(19) United States
(12) Patent Application Publication
(10) Pub. No.: US 2019/0361759 A1
(43) Pub. Date: Nov. 28, 2019

(54) SYSTEM AND METHOD TO IDENTIFY FAILED POINTS OF NETWORK IMPACTS IN REAL TIME

(71) Applicant: AT&T Intellectual Property I, L.P., Atlanta, GA (US)

(72) Inventors: Lucus Haugen, Celina, TX (US); Prince Paulraj, Coppell, TX (US); Christopher Tsai, Plano, TX (US); Hui Miao, Plano, TX (US); Prabhu Gururaj, Richardson, TX (US); Shilpi Harpavat, Plano, TX (US); Sheldon Meredith, Roswell, GA (US)

(21) Appl. No.: 15/986,324

(22) Filed: May 22, 2018

(51) Int. Cl. G06F 11/07; G06F 17/30; G06N 99/00

(52) U.S. Cl. CPC G06F 11/079; G06F 11/0709; G06N 99/005; G06F 11/0772; G06F 17/30377; G06F 11/0751

(57) ABSTRACT

Disclosed are systems, methods and computer-readable media for identifying failed points in a network in real time. The system and method employ a topology database against which parsed and enhanced fault notifications are compared to identify the location of the fault notifications. The fault notifications are associated into a single event. A root cause analysis module having machine learning capabilities is used to match the single event with a predicted root cause by accessing a root cause database established with existing historic data and heuristically derived failure scenarios.

### TECHNICAL FIELD

The present disclosure relates generally to systems, methods and tools for determination of causes of alarms in a network, and more particularly to systems, methods and tools for a real time identification of a point of failure in a network using a topology database and root cause analysis using machine learning.

### BACKGROUND

Networks are fundamentally composed of devices and data transport links between devices (point-to-point or multipoint and physical or wireless media). While some network devices and components will propagate alarms due to faults or degradations in the network, the alarms do not necessarily implicate the failed component or location of the failure—especially if the fault is within the data transport link. Additionally, some networks contain passive (non-powered) devices that do not alarm at all.

Customer trouble reports often only indicate a network fault has occurred but do little to locate the failure for network operations teams. As a result, operations teams often require numerous network dispatches, sending repair technicians to multiple sites (e.g. central offices, field equipment locations, and customer premise locations) to identify fully the root trouble cause.

The problem is greatly compounded during large impact events (e.g. multiple system failures or large physical cable cuts) that create a storm of alarms and customer trouble reports. In these larger impacts, redundant and unnecessary isolation efforts and dispatches often occur.

There is a need to identify failed points of network impact in real time.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for identifying a point of failure in a network, the method including: receiving at a server a plurality of fault alarms from a plurality of network components; converting the plurality of fault alarms into a common format that can be compared against data stored in a topology database where the topology database includes a multilayer network topological inventory resident in memory; correlating each of the plurality of fault alarms to a path and a component for each of the plurality of fault alarm using the topology database; identifying a fault location for each of the plurality of fault alarms; associating the plurality of fault alarms into a single event; accessing a root cause database including a plurality of root causes; matching the single event with a matched root cause; determining a predicted point of failure based on the matched root cause; and generating a new trouble ticket based on the predicted point of failure. Other embodiments of this aspect include corresponding computer systems, apparatus, and computer programs recorded on one or more computer storage devices, each configured to perform the actions of the methods.

Implementations may include one or more of the following features. The method where the step of matching the single event with the matched root cause includes applying a machine learning algorithm to the single event and the plurality of root causes to identify the matched root cause. The method where the root cause database includes historic data. The method where the root cause database includes heuristically derived failure scenarios. The method further may include scoring the predicted point of failure based on an actual root cause to produce a scored predicted root cause, and updating the root cause database based on the scored predicted root cause. The method further may include generating a predicted repair time duration estimation. The method further may include enhancing the single event with developed root cause information developed using machine learning. Implementations of the described techniques may include hardware, a method or process, or computer software on a computer-accessible medium.

One general aspect includes a system having: a network with a plurality of network devices, a topology database including a multilayer network topological inventory, a processor adapted to receive a plurality of fault notifications from a subset of the plurality of network devices, a parsing and enhancement module that converts the plurality of fault notifications into a common format that can be compared against data stored in the topology database, an event module that associates the plurality of fault notifications into a single event, a root cause database, and a root cause analysis module that accesses the root cause database and matches the single event to a predicted root cause.

Implementations may include one or more of the following features. The system where the root cause analysis module includes a machine learning algorithm. The system further including an update module that updates the machine learning algorithm with information about an actual root cause discovered by a repair person. The system further including a ticket module that issues a trouble ticket for remediation of a failure point in the network. The system where the topology database is built from a plurality of inventory databases. The system further including a trouble ticket module coupled to the root cause analysis module for issuing a trouble ticket to instruct correction of a fault identified in the predicted root cause. The system further may include correlating the plurality of fault notifications to specific network paths and the subset of the plurality of network devices. The system where the root cause database is developed from historical trouble ticket data. The system where the topology database is resident in memory. The system further may include a feedback module for providing feedback of an actual root cause discovered by a repair person. The system where the root cause database is established with existing historic data and heuristically derived failure scenarios to supplement information not available in a ticket history. The system where the root cause analysis module includes a machine learning algorithm with a closed loop learning capability. The system further including a scoring module that scores the predicted root cause against an actual root cause. Implementations of the described techniques may include hardware, a method or process, or computer software on a computer-accessible medium.

### BRIEF DESCRIPTION OF THE DRAWINGS

FIG. 1 is a simplified functional block diagram of an embodiment of a system to identify failed points of network impact in a network.

FIG. 2 is a simplified flowchart illustrating an embodiment of a method of identifying failed points of network impact in a network.

FIG. 3 is a simplified functional block diagram of an embodiment of a system to identify failed points of network impact in a network.

### DETAILED DESCRIPTION OF ILLUSTRATIVE EMBODIMENTS

### Introduction

The present disclosure is directed to the simplifications of methods to identify root causes of failure points in a network. Embodiments of the present disclosure recognized that the determination of the root cause of the failure point may be time-consuming and require numerous network dispatches, sending repair technicians to multiple sites to fully identify the root trouble cause of the failure point in a network. Presently, the determination of a root cause of the point of failure in the network may involve significant data parsing, analysis of log and configuration files and multiple inputs by system operators and other personnel. The system and method utilize real time alarms or other fault notifications from network devices and customer trouble reports as they occur, associate them with a multilayer network topological inventory, and use machine learning algorithms to indicate the point of failure in the network. With the failure point identified, the system and method will predict the restoration time. Embodiments of the disclosure use a real-time speed layer to create events and then enhances the event with root cause information from the machine learning algorithm developed and continuously improved with real-time and batch process information.

### Network Environment

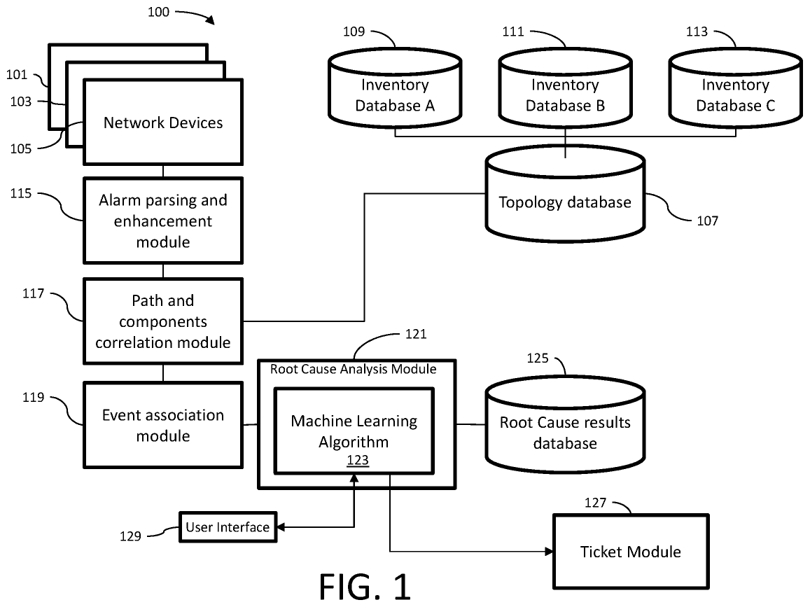

Referring now to the drawings, it is to be understood that like numerals represent like elements through the several figures, and that not all components and or steps described and illustrated with reference to the figures are required for all embodiments. Illustrated in FIG. 1 is an embodiment of a system 100 to identify failed points of network impact in a network.

Associated with the system 100 are a plurality of network devices 101, 103, 105 (only three are shown) which may represent points of failures in the network. Network devices 101, 103, and 105 may be devices that propagate alarms due to faults or degradation in the network, or some or all of them may be passive devices that do not alarm at all. Other sources of fault notifications may be included, such as performance monitoring devices (not shown) that detect anomalies or degradation in network performance, or customer trouble reports.

An embodiment of the system 100 may also include a topology database 107, which contains a multilayer network topological inventory including data relating to network components, location of the network components and paths of the network. The topology database 107 contains data related to the interconnected pattern of network elements. The data in the topology database includes a mapping of the hardware configuration and a mapping the path that the data must take in order to travel around the network. The topology database 107 is created from a plurality of inventory databases such as inventory database A 109, inventory database B 111, and inventory database C 113. Traditional inventory databases identify components, locations and paths. The topology database 107 combines the data from the various inventory databases into a single database. The topology database is built from the inventory databases using “big data” methodologies. The topology database may be resident in memory for faster querying.

An embodiment of the system 100 includes an alarm parsing and enhancement module 115. The alarm parsing and enhancement module 115 receives alarms or trouble reports coming from different devices in different formats, structures and standards. In an embodiment, the parsing and enhancement module 115 may receive network performance data that may be used to identify that a failure of a device has occurred by measuring the performance degradation or deviation from baseline. The alarm parsing and enhancement module 115 reads alarm information against standards applicable to the device and harmonize the information so they can be read by other components in the system 100. The parsed and enhanced alarm information is provided to a path and components correlation module 117 that matches the parsed and enhanced alarm information with data in the topology database 107 to provide impacted topology information to the parsed and enhanced alarm information. The parsed and enhance alarm information including the impacted topology information is provided to an event association module 119 that associates all active alarms and trouble reports into a single event comprising a single event data.

The single event data is provided to a root cause analysis module 121 that includes a machine-learning algorithm 123. Machine learning algorithm 123 is an algorithm that can provide computers with the ability to learn without being explicitly programmed. Example machine learning techniques may include fuzzy logic, prioritization, scoring, and pattern detection. Machine learning algorithm 123 allows a computer to evolve behaviors based on training data. Machine-learning techniques borrow heavily from statistical techniques, e.g. data distributions and probability theory. Machine learning relies on training and cross-validation that involves partitioning a sample of data into complementary subsets, performing the analysis on one subset called the training set, and validating the analysis on the other subset called the validation set or testing set. Cross-validation can provide an estimate of model accuracy.

The root cause analysis module 121 accesses a root cause results database 125 that includes data about patterns of alarms correlated to causes of alarms. The data in root cause results database 125 may include existing historic root cause data and additionally heuristically derived failure scenarios to supplement the information not available in the historic ticket history. The root cause analysis module 121 matches a single event to a predicted root cause in the root cause results database 125. The root cause analysis module 121 may provide a predicted repair estimation associated with the predicted root cause. The root cause analysis module 121 may then communicate with the ticket module 127 to issue a trouble ticket to be addressed by a technician or repair person. By immediately correlating a device alarm or customer report to the specific path and components within a greater network topology, the general fault location is available and alleviates manual—often error prone—searches by Operations teams. Alternatively, the root cause analysis module 125 may interact with a user interface 129 to provide information about the root cause of the alarms. After the technician or repair person corrects the point of failure that is the source of the alarms, the technician may input the point of failure data through the user interface 129 and provide the data to the root cause analysis module 121 for processing by the machine learning algorithm 123 and update the machine learning algorithm 123 and the root cause results database 125. This provides a closed-loop learning process. The system 100 will continuously update the machine learning algorithms 123 based on feedback of actual failure corrections, thereby creating a closed loop machine learning model. The actual root cause found at the restoration of the point of failure may be used to score the predicted root cause to provide feedback to the machine learning algorithm 123 and the root cause results database 125. The feedback to the machine learning algorithm 123 may include supervised learning approaches in which inputs are linked to outputs via a training data set or an unsupervised learning approach where the feedback is provided automatically.

### Methods

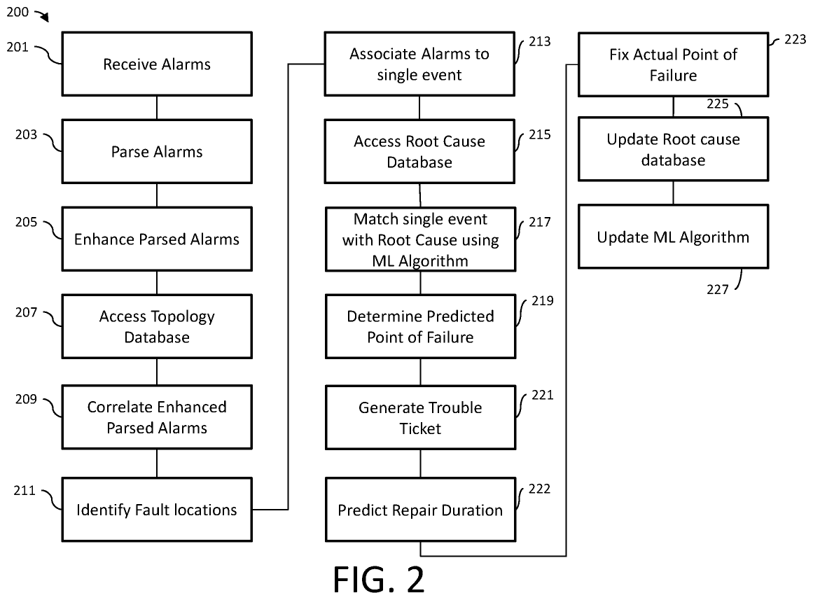

Illustrated in FIG. 2 is an embodiment of a method 200 for identifying failed points of network impacts in real time.

In step 201, the system receives notifications such as fault alarms, trouble reports or network performance data associated with a device failure.

In step 203, notifications may be parsed into a format that can be processed by the system.

In step 205, the parsed notifications may be enhanced with additional information.

In step 207, a topology database is accessed. The topology database contains a multilayer network topological inventory including data relating to network components, location of the network components and paths of the network.

In step 209, the parsed and enhanced notifications are correlated with data from the topology database.

In step 211, the system identifies fault locations based on the correlated data. In step 213 the system associates the notifications to a single event.

In step 215, the system accesses a root cause database which may include existing historic root cause data and heuristically derived failure scenarios.

In step 217, the system matches it to a single event with a root cause using a machine learning algorithm.

In step 219, the system determines a predicted point of failure.

In step 221 the system generates a trouble ticket.

In step 222 the system predicts the repair duration to repair the pint of failure.

In step 223, a person is dispatched to fix the actual point of failure.

In step 225, the root cause database is updated with the actual point of failure.

In step 227, the machine learning algorithm is updated with the actual point of failure.

In one embodiment computer readable media is provided, having instructions stored thereon for execution by a processor of the method described above.

By way of example, and not limitation, computer readable media may comprise computer storage media and communication media. Computer storage media includes volatile and non-volatile, removable and non-removable media implemented in any method or technology for storage of information Such as computer-readable instructions, data structures, program modules, or other data. Computer storage media includes, but is not limited to, RAM, ROM, Erasable Programmable ROM (“EPROM), Electrically Erasable Programmable ROM (“EEPROM), flash memory or other solid state memory technology, CD-ROM, digital versatile disks (“DVD), or other optical storage, magnetic cassettes, magnetic tape, magnetic disk storage or other magnetic storage devices, or any other medium which can be used to store the desired information and which can be accessed by a computer.

While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

### Alternate Embodiment of Network Environment

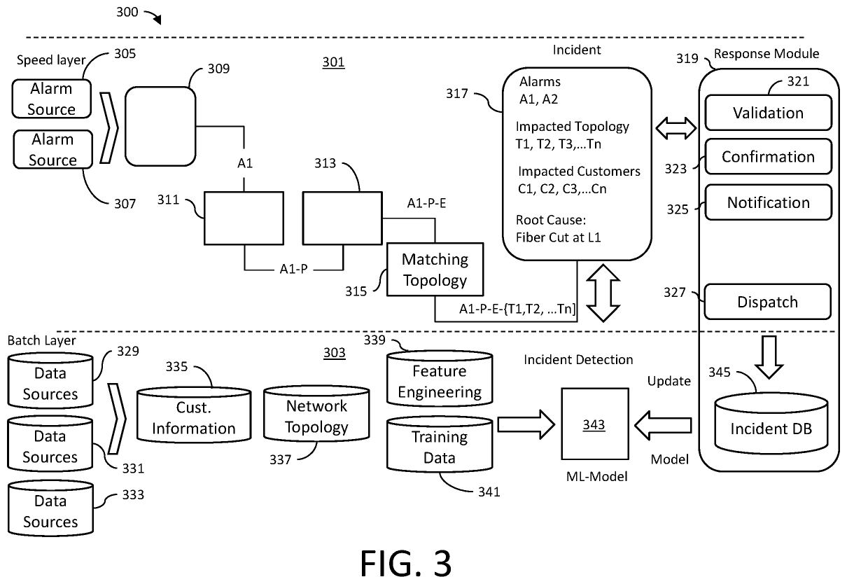

Illustrated in FIG. 3 is an alternate embodiment the network environment of a system 300 for identifying failed points of network impacts in real time. The network environment is divided in two layers, speed layer 301 and batch layer 303. Activities in the speed layer 301 take place real time in memory, while activities in the batch layer have significantly higher latency.

The system 300 includes a plurality of alarms sources, for example alarm source 305 and alarm source 307. Although in this example we refer to alarms sources, any form of notification of a fault on a network device, such as for example, trouble reports, or a degradation in network performance may be employed.

The alarms or notifications may be provided to a collector 309 that collects the alarms and communicates into a parsing module 311 where the alarms or notifications are parsed into a common format. The parsed alarms or notifications are then communicated to an enhancement module 313 that may enhance the parsed alarms or notifications with additional information. The parsed and enhanced alarms or notifications are transmitted to a matching module 315 that matches the parts and enhance alarms or notifications to data in a network topology database residing in the speed layer 301. The matching module 315 transmits the parts and enhance alarms or notifications with network topology data to an incident module 317. The system also includes a response module 319, comprising a validation module 321 a confirmation module 323 and a notification module 325. The notification module 325 communicates with the dispatch module 327.

The batch layer 303 is comprised of a plurality of data sources such as illustrated data source 329, data source 331 and data source 333. The batch layer may also include a customer information data store 335 and a network topology data store 337. Also included in batch layer 303 may be a feature engineering data store and a training data store. A machine learning model 343 is provided that access data from the aforementioned data stores and an incident database 345. The incident module 317 accesses the machine learning model 343 that includes a machine learning algorithm, and is provided with root cause information from the aforementioned data stores in the incident database.

Those skilled in the art having reference to this specification will recognize that the disclose embodiments provides numerous advantages in methods for identifying points of failure in a network. The benefits of the various embodiments disclosed include the elimination of manual troubleshooting steps for operations personnel, and effectively automating the root cause discovery of a fault condition. As result, multiple field dispatches will not be required to isolate fault conditions. Further, when a large outage occurs, the many individual network alarms and trouble reports are automatically combined and assessed as a single event. This further reduces inefficiencies and redundant dispatches.

It is to be understood that the above-described embodiments are merely illustrative principles of the embodiments and that many variations may be devised by those skilled in the art, without departing from the scope of the disclose embodiments. It is, therefore, intended that such variations be included within the scope of the claims.

What is claimed:

1. A method for identifying a point of failure in a network, the method comprising:
receiving at a server a plurality of fault alarms from a plurality of network components;
converting the plurality of fault alarms into a set of parsed alarms with a common format that can be compared against data stored in a topology database wherein the topology database comprises a multilayer network topological inventory resident in memory;
correlating each member of the set of parsed alarms into a set of enhanced alarms using the topology database, wherein each member of the set of enhanced alarms includes information about a path and one of the plurality of network components;
identifying a fault location for each of the set of enhanced alarms;
associating the set of enhanced alarms into a single event;
accessing a root cause database comprising a plurality of root causes;
matching the single event with a matched root cause;
determining a predicted point of failure based on the matched root cause; and
generating a new trouble ticket based on the predicted point of failure.

2. The method of claim 1 wherein the step of matching the single event with the matched root cause comprises applying a machine learning algorithm to the single event and the plurality of root causes to identify the matched root cause.

3. The method of claim 1 wherein the root cause database comprises historic data.

4. The method of claim 1 wherein the root cause database comprises heuristically derived failure scenarios.

5. The method of claim 1 further comprising:
scoring the predicted point of failure based on an actual root cause to produce a scored predicted root cause; and
updating the root cause database based on the scored predicted root cause.

6. The method of claim 1 further comprising generating a predicted repair time duration estimation.

7. The method of claim 1 further comprising enhancing the single event with developed root cause information developed using machine learning.

8. A system comprising:
a network comprising a plurality of network devices;
a topology database comprising a multilayer network topological inventory;
a processor adapted to receive a plurality of fault alarms from a subset of the plurality of network devices;
a parsing module that converts the plurality of fault alarms into a set of parsed alarms having a common format that can be compared against data stored in the topology database;
a path and component correlation module that generates a set of enhanced alarms from the set of parsed alarms;
an event module that associates the set of enhanced alarms into a single event;
a root cause database; and
a root cause analysis module that accesses the root cause database and matches the single event to a predicted root cause.

9. The system of claim 8 wherein the root cause analysis module comprises a machine learning algorithm.

10. The system of claim 8 further comprising a ticket module that issues a trouble ticket for remediation of a failure point in the network.

11. The system of claim 8 wherein the topology database is built from a plurality of inventory databases.

12. The system of claim 8 further comprising a trouble ticket module coupled to the root cause analysis module for issuing a trouble ticket to instruct correction of a fault identified in the predicted root cause.

13. The system of claim 8, wherein the set of enhanced alarms include information about the subset of the plurality of network devices and path information associated with the subset of the plurality of network devices.

14. The system of claim 8 wherein the root cause database is developed from historical trouble ticket data.

15. The system of claim 8 wherein the topology database is resident in memory.

16. The system of claim 8 further comprising a feedback module for providing feedback of an actual root cause discovered by a repair person.

17. The system of claim 8 wherein the root cause database is established with existing historic data and heuristically derived failure scenarios to supplement information not available in ticket history.

18. The system of claim 8 wherein the root cause analysis module comprises a machine learning algorithm with a closed loop learning capability.

19. The system of claim 8 further comprising a scoring module that scores the predicted root cause against an actual root cause.

20. The system of claim 9 further comprising an update module that updates the machine learning algorithm with information about an actual root cause discovered by a repair person.
